(19) United States
(12) Patent Application Publication
(10) Pub. No.: US 2016/0371697 A1
(43) Pub. Date: Dec. 22, 2016

(54) TRANSACTION FRAUD DETECTION

(71) Applicant: International Business Machines Corporation, Armonk, NY (US)

(72) Inventors: John J. Auvenshine, Tucson, AZ (US); John T. Olson, Tucson, AZ (US); Nedzad Taljanovic, Tucson, AZ (US)

(21) Appl. No.: 14/745,913

(22) Filed: Jun. 22, 2015

(51) Int. Cl. G06Q 20/40; G06Q 20/10; G06Q 20/32; H04L 29/06

(52) U.S. Cl. CPC G06Q 20/4016; H04L 63/1425; H04L 63/306; H04L 63/0853; G06Q 20/10; G06Q 20/3224

(57) ABSTRACT

An apparatus, method, system, and program product are disclosed for transaction fraud detection. A region determination module determines a valid region for a transaction. The region determination module includes at least one of an itinerary module that determines the valid region for the transaction based at least partly on a travel itinerary of a user and a network module that determines the valid region for the transaction based at least partly on two-way communication between an information handling device and a network. The travel itinerary may be obtained dynamically by accessing a third-party account of the user. The information handling device is not used to initiate the transaction. An approval module approves the transaction if a location of the transaction is within the valid region.

### FIELD

The subject matter disclosed herein relates to transactions, and more particularly relates to transaction fraud detection.

### BACKGROUND

Transactions, such as purchases, may occur using a bank card, such as a credit card or a debit card. Certain unauthorized and/or fraudulent transactions may be attempted using a stolen bank card or stolen information from a bank card.

### BRIEF SUMMARY

An apparatus for transaction fraud detection is disclosed. A method and computer program product also perform the functions of the apparatus. In one embodiment, an apparatus includes a region determination module that determines a valid region for a transaction. The region determination module includes at least one of an itinerary module that determines the valid region for the transaction based at least partly on a travel itinerary of a user and a network module that determines the valid region for the transaction based at least partly on two-way communication between an information handling device and a network. In certain embodiments, the travel itinerary is obtained dynamically by accessing a third-party account of the user. In some embodiments, the information handling device is not used to initiate the transaction. The apparatus, in a further embodiment, includes an approval module that approves the transaction if a location of the transaction is within the valid region.

A method for transaction fraud detection, in one embodiment, includes determining a valid region for a transaction based on at least one of a travel itinerary of a user and two-way communication between an information handling device and a network. In some embodiments, the travel itinerary is obtained dynamically by accessing a third-party account of the user. In certain embodiments, the information handling device is not used to initiate the transaction. The method includes, in one embodiment, approving the transaction if a location of the transaction is within the valid region.

Another method for transaction fraud detection, in some embodiments, includes determining a first valid region for a transaction based at least partly on a travel itinerary of a user. In such embodiments, the travel itinerary is obtained dynamically by accessing a third-party account of the user. The method may include determining a second valid region for the transaction based at least partly on two-way communication between an information handling device and a network. In such embodiments, the information handling device is not used to initiate the transaction. The method, in certain embodiments, includes approving the transaction if a location of the transaction is within the first valid region, the second valid region, or some combination thereof.

In one embodiment, a computer program product for transaction fraud detection includes a computer readable storage medium having program instructions embodied therewith. The program instructions, in some embodiments, are executable by a processor to cause the processor to determine a valid region for a transaction based on at least one of a travel itinerary of a user and two-way communication between an information handling device and a network. In certain embodiments, the travel itinerary is obtained dynamically by accessing a third-party account of the user. In some embodiments, the information handling device is not used to initiate the transaction. The program instructions, in one embodiment, are executable by a processor to cause the processor to approve the transaction if a location of the transaction is within the valid region.

In some embodiments, a system for transaction fraud detection includes a processor. The system, in certain embodiments, includes a region determination module that determines, by use of the processor, a valid region for a transaction, the region determination module comprising at least one of an itinerary module that determines the valid region for the transaction based at least partly on a travel itinerary of a user, a network module that determines the valid region for the transaction based at least partly on two-way communication between an information handling device and a network, and a positioning module that determines the valid region for the transaction based at least partly on a geospatial position of the information handling device. In such embodiments, the travel itinerary is obtained dynamically by accessing a third-party account of the user. In some embodiments, the information handling device is not used to initiate the transaction. The system includes, in certain embodiments, an approval module that approves the transaction if a location of the transaction is within the valid region.

### BRIEF DESCRIPTION OF THE DRAWINGS

In order that the advantages of the embodiments of the invention will be readily understood, a more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a system for transaction fraud detection in accordance with one embodiment of the present invention;

FIG. 2 is a schematic block diagram illustrating one embodiment of a module for transaction fraud detection in accordance with one embodiment of the present invention;

FIG. 3 is a schematic block diagram illustrating one embodiment of another module for transaction fraud detection in accordance with one embodiment of the present invention;

FIG. 4 is a schematic block diagram illustrating one embodiment of operation of a positioning module in accordance with one embodiment of the present invention;

FIG. 5 is a schematic block diagram illustrating one embodiment of operation of an itinerary module in accordance with one embodiment of the present invention;

FIG. 6 is a schematic block diagram illustrating one embodiment of operation of a network module in accordance with one embodiment of the present invention;

FIG. 7 is a schematic flow chart diagram illustrating one embodiment of a method for transaction fraud detection in accordance with one embodiment of the present invention;

FIG. 8 is a schematic flow chart diagram illustrating one embodiment of another method for transaction fraud detection in accordance with one embodiment of the present invention;

FIG. 9 is a schematic flow chart diagram illustrating one embodiment of a further method for transaction fraud detection in accordance with one embodiment of the present invention; and

FIG. 10 is a schematic flow chart diagram illustrating one embodiment of an additional method for transaction fraud detection in accordance with one embodiment of the present invention.

### DETAILED DESCRIPTION

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, advantages, and characteristics of the embodiments may be combined in any suitable manner. One skilled in the relevant art will recognize that the embodiments may be practiced without one or more of the specific features or advantages of a particular embodiment. In other instances, additional features and advantages may be recognized in certain embodiments that may not be present in all embodiments.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (“RAM”), a read-only memory (“ROM”), an erasable programmable read-only memory (“EPROM” or Flash memory), a static random access memory (“SRAM”), a portable compact disc read-only memory (“CD-ROM”), a digital versatile disk (“DVD”), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (“ISA”) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider). In some embodiments, electronic circuitry including, for example, programmable logic circuitry, field-programmable gate arrays (“FPGA”), or programmable logic arrays (“PLA”) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of program instructions may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

The schematic flowchart diagrams and/or schematic block diagrams in the Figures illustrate the architecture, functionality, and operation of possible implementations. It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Although various arrow types and line types may be employed in the flowchart and/or block diagrams, they are understood not to limit the scope of the corresponding embodiments. Indeed, some arrows or other connectors may be used to indicate only an exemplary logical flow of the depicted embodiment.

The description of elements in each figure may refer to elements of proceeding figures. Like numbers refer to like elements in all figures, including alternate embodiments of like elements.

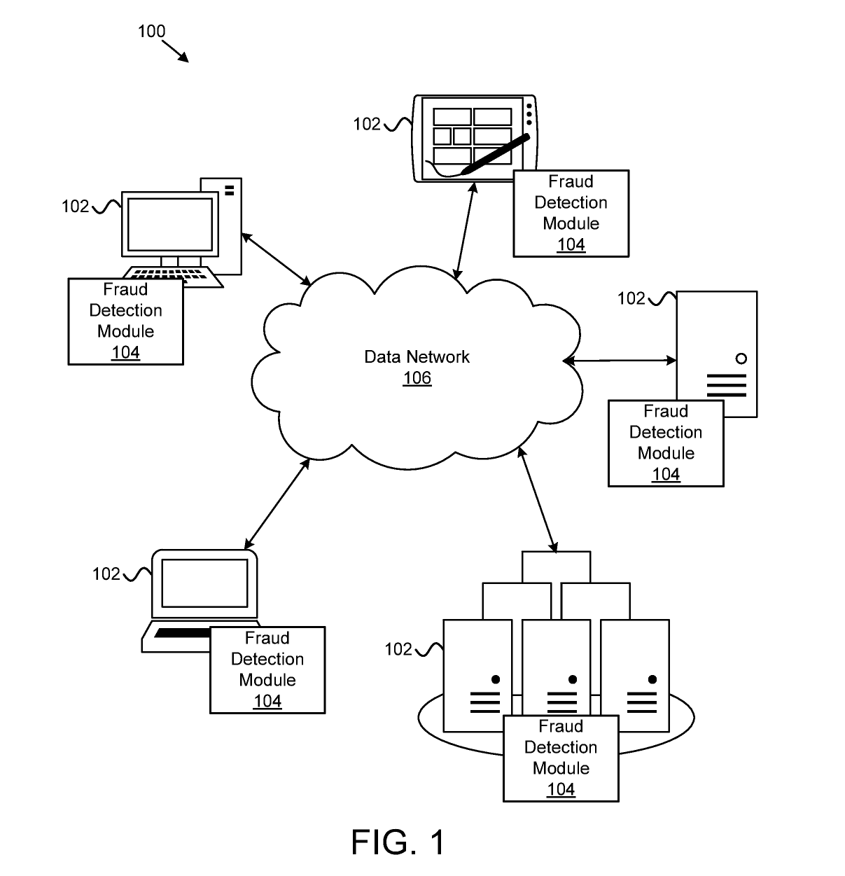

FIG. 1 depicts one embodiment of a system 100 for transaction fraud detection. In one embodiment, the system 100 includes information handling devices 102, fraud detection modules 104, and networks 106. Even though a particular number of information handling devices 102, fraud detection modules 104, and networks 106 are depicted in the system 100 of FIG. 1, one of skill in the art will recognize that any number or configuration of information handling devices 102, fraud detection modules 104, and networks 106 may be present in the system 100.

The information handling devices 102, in certain embodiments, include computing devices, such as desktop computers, laptop computers, tablet computers, smart phones, smart televisions, smart watches, or the like. The information handling devices 102 may also include servers, such as web servers, application servers, file servers, media servers, email servers, cloud servers, backup servers, virtual servers, or the like. In some embodiments, the information handling devices 102 may be part of a data center used for data storage, data backup, data replication, disaster recovery, and/or the like. The information handling devices 102 may be located in geographically remote locations, in the same geographic location (e.g., the same data center), or some combination of both.

The information handling devices 102 may be configured to store data, backup data, replicate data, or the like. For example, the information handling devices 102 may be configured to perform synchronous or asynchronous data replication. In another example, information handling devices 102 may be configured as failover devices for one or more associated production information handling devices 102. Moreover, the information handling devices 102 may comprise one or more storage volumes, storage devices, RAID devices or configurations, or the like, such as hard-disk drives, solid-state drives, flash memory devices, random-access memory (RAM), SATA devices, tape devices, or the like. In some embodiments, the information handling devices 102 are in communication via one or more data networks 106, described below.

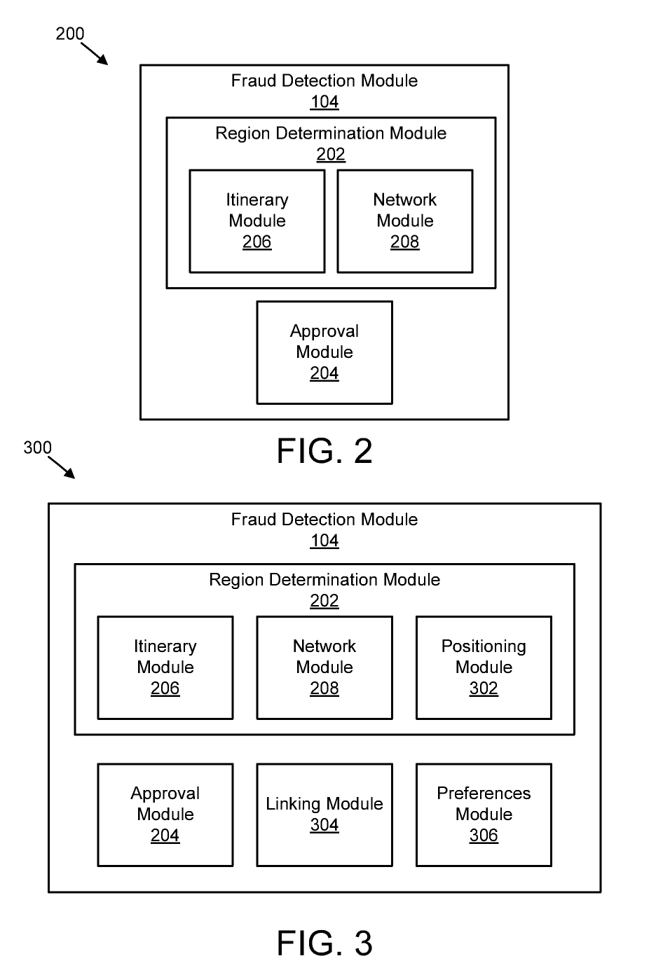

In one embodiment, the fraud detection module 104 determines a valid region for a transaction based on at least one of a travel itinerary of a user and two-way communication between the information handling device 102 and a network. The travel itinerary may be obtained dynamically by accessing a third-party account of the user, such as a travel account. In some embodiments, the information handling device 102 is not used to initiate the transaction. In certain embodiments, the fraud detection module 104 approves the transaction if a location of the transaction is within the valid region. In this manner, the fraud detection module 104 may dynamically approve transactions in which the travel itinerary and/or two-way communication between the information handling device 102 and a network indicate that the location of the user is within a predetermined distance from the location of the transaction, otherwise transactions may necessitate notifying a financial institution of planned travel. Furthermore, potentially fraudulent transactions may be flagged for notification to the financial institution. Ultimately, this may allow a user to complete transactions while traveling without notifying financial institutions involved in the transactions ahead of time, yet still protect the users account from fraudulent transactions. In certain embodiments, as described below with reference to FIGS. 2 and 3, the fraud detection module 104 includes multiple modules that perform the operations of the fraud detection module 104.

The data network 106, in one embodiment, includes a digital communication network that transmits digital communications. The data network 106 may include a wireless network, such as a wireless cellular network, a local wireless network, such as a Wi-Fi network, a Bluetooth® network, a near-field communication (“NFC”) network, an ad hoc network, and/or the like. The data network 106 may include a wide area network (“WAN”), a storage area network (“SAN”), a local area network (“LAN”), an optical fiber network, the internet, or other digital communication network. The data network 106 may include two or more networks. The data network 106 may include one or more servers, routers, switches, and/or other networking equipment. The data network 106 may also include computer readable storage media, such as a hard disk drive, an optical drive, non-volatile memory, random access memory (“RAM”), or the like.

FIG. 2 is a schematic block diagram illustrating one embodiment of a module 200 for transaction fraud detection. In one embodiment, the module 200 includes an embodiment of a fraud detection module 104. The fraud detection module 104, in various embodiment, includes one or more of a region determination module 202 and an approval module 204, which are described in more detail below.

In one embodiment, the region determination module 202 determines a valid region for authorizing a transaction. The region determination module 202, in certain embodiments, includes an itinerary module 206 and a network module 208. The valid region for a transaction may be any suitable region such as a city, metropolis, county, state, country, region, union, continent, area that encompasses a predetermined distance from a calculated location of a user, and so forth. In certain embodiments, the transaction may be any suitable financial transaction, such as a financial purchase, a financial sale, a withdrawal, a deposit, a balance check, a refund, bank card use, credit card use, debit card use, electronic purchase, electronic sale, and so forth. As may be appreciated, a transaction may occur if it is authorized and a transaction may be blocked if it is not authorized. Moreover, a blocked transaction may be reported as being fraudulent.

The itinerary module 206, in some embodiments, determines the valid region for the transaction based at least partly on a travel itinerary of a user. The travel itinerary of the user may include dates and locations of travel for the user and/or other travelers. The travel itinerary may include one or more of each of a departure date and/or time, an arrival date and/or time, an airline, a flight number, a seat number, an accommodation check-in date and/or time, an accommodation check-out date and/or time, an accommodation name, an accommodation location, a rental vehicle company, a rental vehicle reservation, an event name, an event date, an event time, and so forth.

In one embodiment, the travel itinerary is obtained dynamically by accessing a third-party account of the user. For example, in certain embodiments, the third-party account of the user is a travel account. The travel account may be an account used by the user to book and/or arrange travel. For example, the travel account may be an airline account, an accommodation (e.g., hotel, motel, bed and breakfast, timeshare, rental, etc.) account, an agency account, a rewards account, a travel company account, a discount account, a trip planning account, a car rental account, and so forth. In some embodiments, the third-party account may be any type of account of the user, such as an email account, a social media account, a blog account, and so forth. As may be appreciated, travel related information may be obtained dynamically from such an account of the user. In some embodiments, the third-party account is associated with the user. For example, the itinerary module 206 may be used to obtain, store, and/or use third-party account information provided by the user and/or stored with account information of the user. Thus, an association between the third-party account and the user may be established by storing the third-party account information with the user account information.

A valid region for a transaction may be determined based on the travel itinerary. In one embodiment, a valid region for a transaction may be a region that includes all areas within a predetermined distance from an item on the travel itinerary. It should be noted that for each valid region, a valid time period may be tied to the valid region such that the valid region is only valid for a specific time period. For example, a travel itinerary may indicate that a user is to arrive in Frankfurt, Germany at 4:30 pm on Apr. 1, 2025 and depart Frankfurt, Germany at 1:30 am on Apr. 5, 2025. In such an embodiment, the valid region may be an area that includes any location within 100 miles of Frankfurt, Germany. Moreover, the valid time period during which transactions originating within the valid region are valid may include 4:00 pm on Apr. 1, 2025 through 2:30 am on Apr. 5, 2025.

As may be appreciated, the criteria used to determine the valid region, such as the valid region including all areas within a specific distance from an itinerary location may be selectable by the user. For example, the user may select that all locations within 5 miles, 10 miles, 20 miles, 50 miles, 100 miles, 200 miles, and so forth from an itinerary location may be part of the valid region. Furthermore, the criteria used to determine the valid time period associated with the valid region may also be selectable by the user. For example, the user may select a time before and/or after an itinerary time to be included within the valid time period.

The network module 208, in certain embodiments, determines the valid region for the transaction based at least partly on two-way communication between the information handling device 102 and a network. In some embodiments, the network may be used to determine a location of the information handling device 102 based on the two-way communication between the information handling device 102 and the network. For example, the information handling device 102 may communicate with the network using a Wi-Fi connection, a cellular tower, and so forth. The network device that the information handling device 102 communicates with may be used to determine the location of the information handling device 102 using any suitable technique. Based on the determined location of the information handling device 102, the valid region may be determined.

In some embodiments, the network module 208 may initiate a phone call or a text message to be sent from the information handling device 102 for use in determining whether the transaction is within the valid region. In such embodiments, the phone call and/or text message may be traced to determine where the phone call and/or text message originated.

In some embodiments, the information handling device 102 is not used to initiate the transaction. For example, the transaction may be initiated using a bank card and/or a device separate from the information handling device 102. Moreover, in one embodiment, the information handling device 102 is associated with the user. For example, a user account of the user that corresponds to the transaction may be linked to the information handling device 102. In certain embodiment, the information handling device 102 may be registered with the user account of the user to form the association between the information handling device 102 and the user. As set forth above, the information handling device 102 may be a mobile phone, a watch, a tablet computer, a laptop computer, a desktop computer, and so forth. The network may be any suitable network, such as a cellular network, a local-area network (“LAN”), a wide-area network (“WAN”), and so forth.

The approval module 204, in one embodiment, approves the transaction if a location of the transaction is within the valid region. In some embodiments, the approval module 204 may approve the transaction if the location of the transaction is within a predetermined distance from the valid region. In certain embodiments, the approval module 204 may approve the transaction if the location of the transaction is within a valid region determined from one or more modules of the region determination module 202. For example, the approval module 204 may approve the transaction if the location of the transaction is within a valid region determined from the itinerary module 206, the network module 208, and/or both the itinerary module 206 and the network module 208. In some embodiments, the approval module 204 may use additional verification from the user before approving a transaction. For example, the approval module 204 may use a password, a personal identification number (“PIN”), a security question, a biometric identification (e.g., fingerprint, etc.), and so forth. In certain embodiments, the additional verification may need to be provided within a predetermined period of time for the approval of the transaction. In some embodiments, the predetermined period of time may be selected by the user.

In certain embodiments, the approval module 204 may receive a confidence score (e.g., 1 to 100) from each module in the region determine module 202 (e.g., itinerary module 206, network module 208, and so forth) based on an algorithm at each module. The confidence score may be used to represent how likely it is that the attempted transaction is valid (e.g., not fraudulent) based on the particular module. In some embodiments, a higher confidence score represents a transaction that is more likely to be valid, while a lower confidence score represents a transaction that is more likely to be fraudulent. For example, a score of 100 may indicate that the transaction is valid (e.g., not suspicious), and a score of 1 may indicate that the transaction is fraudulent. Intermediate scores may indicate a middle degree of confidence. In other embodiments, a higher confidence score represents a transaction that is more likely to be fraudulent, while a lower confidence score represents a transaction that is more likely to be valid.

The approval module 204 may aggregate inputs from other modules to determine an aggregated rating. For example, one algorithm may sum two, three, or more confidence scores. In some embodiments, if the summed confidence score is greater than fifty percent of the total possible summed confidence scores, the transaction may be approved. As may be appreciated, if a transaction is determined to be likely to be fraudulent, the transaction may be reported as being likely to be fraudulent. On the other hand, if the transaction is determined to be approved, the transaction will be processed.

In some embodiments, at least a portion of the region determination module 202 and the approval module 204 includes one or more of hardware and executable code. In such embodiments, the executable code may be stored on one or more computer readable storage media.

FIG. 3 is a schematic block diagram illustrating one embodiment of another module 300 for transaction fraud detection. In one embodiment, the module 300 includes an embodiment of a fraud detection module 104. The fraud detection module 104, in various embodiments, includes one or more of a region determination module 202, an approval module 204, an itinerary module 206, and a network module 208, which may be substantially similar to the region determination module 202, the approval module 204, the itinerary module 206, and the network module 208 described above. The fraud detection module 104 may also include one or more of a positioning module 302, a linking module 304, and a preferences module 306, which are described in more detail below.

In one embodiment, the positioning module 302 determines the valid region for the transaction based at least partly on a geospatial position of the information handling device 102. For example, the positioning module 302 may receive geospatial data and determine a geospatial position of the information handling device 102 using the geospatial data. The positioning module 302 may then determine the valid region for the transaction based on the determined geospatial position. In one embodiment, the geospatial data may be received from a Global Positioning System (“GPS”).

The linking module 304, in certain embodiments, links the third-party account to a user account of the user. In some embodiments, the linking module 304 may be used to store third-party account data, use third-party account data of the user to access the third-party account of the user, obtain third-party account data from the user, and so forth.

In one embodiment, the preferences module 306 enables the user to select one or both of the itinerary module 206 and the network module 208 for determining the valid region for the transaction. In another embodiment, the preferences module 306 enables the user to select one or more of the itinerary module 206, the network module 208, and the positioning module 302 for determining the valid region of the transaction. Moreover, in some embodiments, the preferences module 306 enables the user to select tolerances for the valid region, tolerances corresponding to the travel itinerary and the valid region, and so forth.

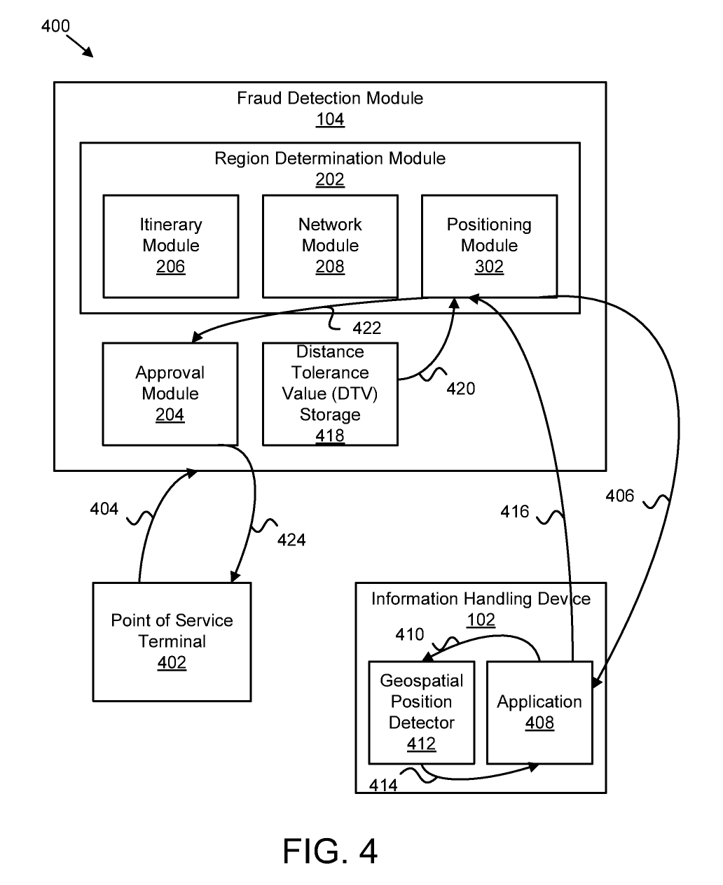

FIG. 4 is a schematic block diagram 400 illustrating one embodiment of operation of a positioning module 302. In the illustrated embodiment, a point of service (“POS”) terminal 402 provides a transaction request 404 to the fraud detection module 104. In some embodiments, the fraud detection module 104 may operate as part of hardware and/or software of a transaction facilitating company, such as a bank or credit card company. As may be appreciated, the POS terminal 402 may be any suitable device used to initiate, complete, facilitate, and/or execute the transaction, such as a terminal used at a register in a store or an automated teller machine (“ATM”).

The positioning module 302 sends a location request 406 to the information handling device 102 to obtain information about the location of the information handling device 102. In certain embodiments, the information handling device 102 includes an application 408 that receives the location request 406 and facilitates determining the location of the information handling device 102. For example, in embodiments in which the information handling device 102 is a mobile phone, the application 408 may be a mobile phone application.

The application 408 sends a geospatial location request 410 to a geospatial position detector 412 of the information handling device 102. In some embodiments, the geospatial location request 410 may include a request for a GPS location and the geospatial position detector 412 may include a GPS location detection device. The geospatial position detector 412 provides a geospatial location 414 of the information handling device 102 to the application 408.

The application 408 then provides location information 416 to the positioning module 302. The fraud detection module 104 includes a distance tolerance value (“DTV”) storage 418 that includes a distance tolerance. The distance tolerance may be, in certain embodiments, a maximum difference in geospatial location between the information handling device 102 and another location, such as the user's home city, state, or country, and/or the location of the transaction. The DTV storage 418 provides the distance tolerance 420 to the positioning module 302.

The positioning module 302, in one embodiment, determines whether the difference between the location information 416 and location of the transaction is within the distance tolerance 420. In some embodiments, the positioning module 302 may determine a confidence factor based on the difference between the location information 416 and the location of the transaction. The positioning module 302 provides preliminary approval and/or the confidence factor 422 to the approval module 204. Based on settings of the approval module 204, the approval module 204 may approve or deny the transaction and provide the approval or denial 424 to the POS terminal 402.

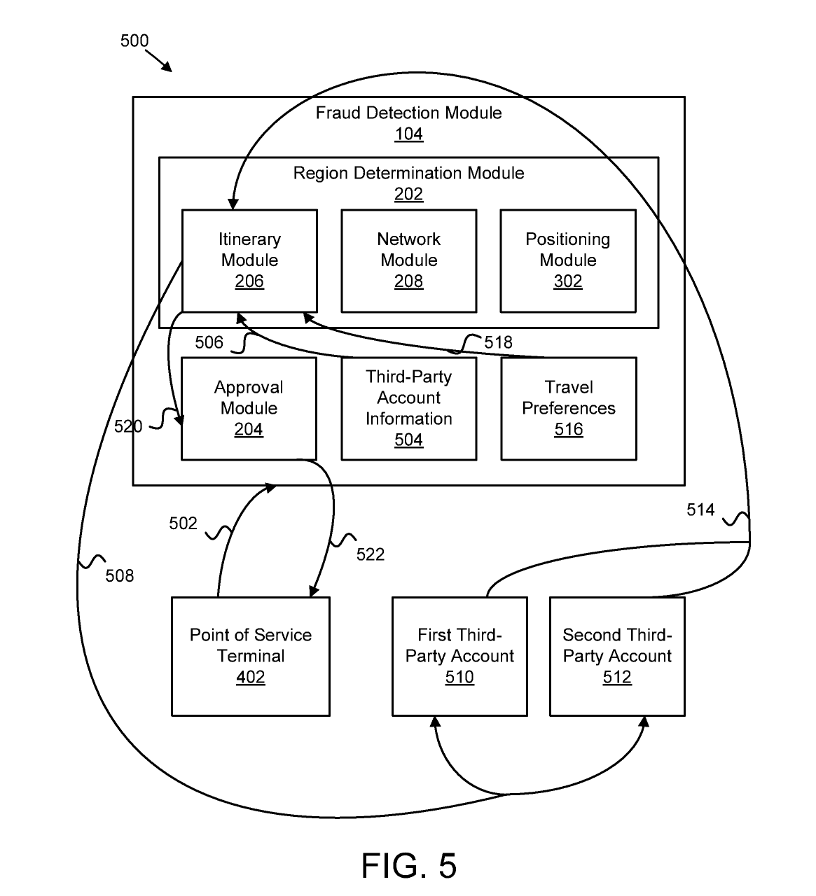

FIG. 5 is a schematic block diagram 500 illustrating one embodiment of operation of an itinerary module 206. In the illustrated embodiment, the POS terminal 402 provides a transaction request 502 to the fraud detection module 104. In some embodiments, the fraud detection module 104 may operate as part of hardware and/or software of a transaction facilitating company, such as a bank or credit card company. As may be appreciated, the POS terminal 402 may be any suitable device used to initiate, complete, facilitate, and/or execute the transaction, such as a terminal used at a register in a store or an automated teller machine (“ATM”).

Third-party account information 504 includes account information for accessing travel information corresponding to the user. In certain embodiments, the third-party account information 504 may include travel company website registration information, email account information, social media account information, and so forth. The third-party account information 504 is provided 506 to the itinerary module 206. The itinerary module 206 requests travel information 508 from one or more third-party accounts, such as the illustrated first third-party account 510 and second third-party account 512. In certain embodiments, the request for travel information 508 may be a request for current and/or upcoming travel plans.

Travel information 514 from the one or more third-party accounts is provided to the itinerary module 206. In addition, travel preferences 516 are provided 518 to the itinerary module 206. As may be appreciated, the travel preferences 516 may include a maximum distance of a transaction from a destination location, a maximum time of a transaction from a travel time, and so forth.

The itinerary module 206 determines whether the difference between the current date, time, and/or location of the POS terminal 402 and the travel information 514 is within the criteria found in the travel preferences 516. In some embodiments, the itinerary module 206 may determine a confidence factor based on the difference between the current date, time, and/or location of the POS terminal 402 and the travel information 514, and the travel preferences 516. The itinerary module 206 provides preliminary approval and/or the confidence factor 520 to the approval module 204. Based on settings of the approval module 204, the approval module 204 may approve or deny the transaction and provide the approval or denial 522 to the POS terminal 402.

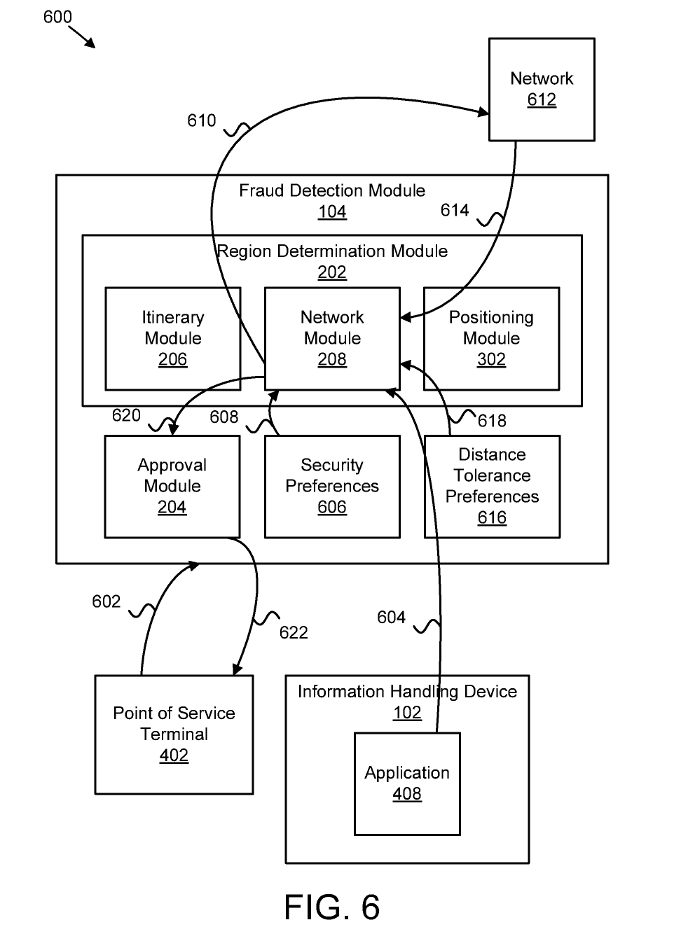

FIG. 6 is a schematic block diagram 600 illustrating one embodiment of operation of a network module 208. In the illustrated embodiment, the POS terminal 402 provides a transaction request 602 to the fraud detection module 104. In some embodiments, the fraud detection module 104 may operate as part of hardware and/or software of a transaction facilitating company, such as a bank or credit card company. As may be appreciated, the POS terminal 402 may be any suitable device used to initiate, complete, facilitate, and/or execute the transaction, such as a terminal used at a register in a store or an automated teller machine (“ATM”).

In certain embodiments, the application 408 may be used to contact 604 the network module 208 of the fraud detection module 104. Before and/or during the application 408 contacting 604 the network module 208, the application 408 may receive authentication from the user to verify the user's identity (e.g., via a password, PIN, biometrics, etc.). For example, the application 408 may contact the network module 208 and provide authentication data 604 to the network module 208 to verify the user's identity. Moreover, security preferences 606 may be provided 608 to the network module 208. The security preferences 606 may include the user's selected security preferences to facilitate verifying the user's identity. The network module 208 compares the security preferences 606 to the authentication data 604 and determines whether to proceed with authorizing the transaction. In certain embodiments, the transaction only proceeds if the authentication data 604 is received within a predetermined time period, such as a time period selected by the user.

After the user is authenticated, the network module 208 requests location information 610 from a network 612 that the application 408 used to contact the network module 208. In one embodiment, requesting location information 610 from the network 612 includes requesting the location of a cellular tower that serviced a text message and/or a phone call that included the authentication data 604. In another embodiment, requesting location information 610 from the network 612 includes requesting the location of an electronic device that serviced a data transmission that included the authentication data 604.

The network 612 provides location information data 614 to the network module 208. In one embodiment, a cellular tower that serviced a text message and/or a phone call that included the authentication data 604 provides the location information data 614 to the network module 208. In another embodiment, an electronic device that serviced a data transmission that included the authentication data 604 provides the location information data 614 to the network module 208.

Distance tolerance preferences 616 are provided 618 to the network module 208. The distance tolerance preferences 616 may include, in certain embodiments, a maximum difference in location between the location information data 614 and the location of the transaction.

The network module 208 determines whether the difference between the location information data 614 and the location of the transaction is within the distance tolerance preferences 616. In some embodiments, the network module 208 may determine a confidence factor based on the difference between the location information data 614 and the location of the transaction. The network module 208 provides preliminary approval and/or the confidence factor 620 to the approval module 204. Based on settings of the approval module 204, the approval module 204 may approve or deny the transaction and provide the approval or denial 622 to the POS terminal 402.

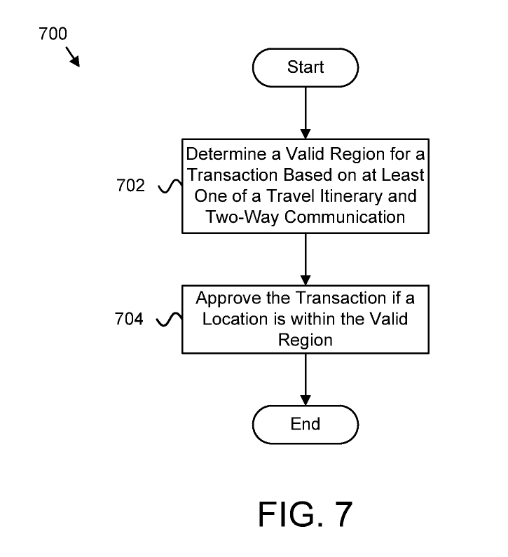

FIG. 7 is a schematic flow chart diagram illustrating one embodiment of a method 700 for transaction fraud detection. In one embodiment, the method 700 begins and the fraud detection module 104 determines 702 a valid region for a transaction based on at least one of a travel itinerary of a user and two-way communication between an information handling device 102 and the network 612. In some embodiments, the itinerary module 206 determines 702 the valid region for a transaction based on a travel itinerary and/or the network module 208 determines 702 the valid region for a transaction based on two-way communication between the information handling device 102 and the network 612. In certain embodiments, the travel itinerary is obtained dynamically by accessing a third-party account of the user. Moreover, in one embodiment, the information handling device 102 is not used to initiate the transaction. The method 700, in some embodiments, approves 704 the transaction, using the approval module 204, if a location of the transaction is within the valid range, and the method 700 ends.

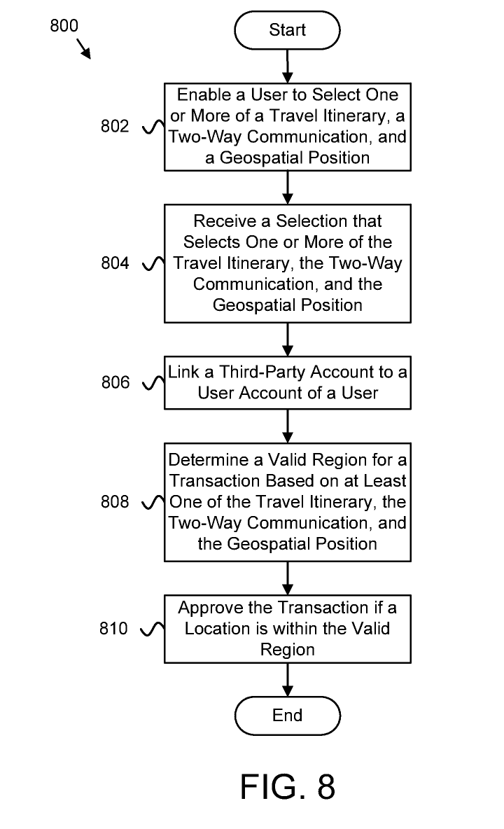

FIG. 8 is a schematic flow chart diagram illustrating one embodiment of another method 800 for transaction fraud detection. In one embodiment, the method 800 begins and the fraud detection module 104 enables 802 a user to select one or more of a travel itinerary, a two-way communication, and a geospatial position to be used in determining a valid region for a transaction. In some embodiments, the preferences module 306 enables 802 the user to select one or more of the travel itinerary, the two-way communication, and the geospatial position to be used in determining the valid region for the transaction. Moreover, the fraud detection module 104 receives 804 a selection of one or more of the travel itinerary, the two-way communication, and the geospatial position to be used in determining the valid region for the transaction. In some embodiments, the preferences module 306 receives 804 the selection of one or more of the travel itinerary, the two-way communication, and the geospatial position to be used in determining the valid region for the transaction.

The fraud detection module 104 links 806 a third-party account to a user account of the user. In some embodiments, the linking module 304 links 806 the third-party account to the user account of the user. The fraud detection module 104 determines 808 a valid region for a transaction based on at least one of the travel itinerary of the user, the two-way communication between an information handling device 102 and the network 612, and the geospatial position of the information handling device 102. In some embodiments, the itinerary module 206 determines 808 the valid region for a transaction based on a travel itinerary, the network module 208 determines 808 the valid region for a transaction based on two-way communication between the information handling device 102 and the network 612, and/or the positioning module 302 determines 808 the valid region for a transaction based on the geospatial position of the information handling device 102. In certain embodiments, the travel itinerary is obtained dynamically by accessing a third-party account of the user. Moreover, in one embodiment, the information handling device 102 is not used to initiate the transaction. The method 800, in some embodiments, approves 810 the transaction, using the approval module 204, if a location of the transaction is within the valid range, and the method 800 ends.

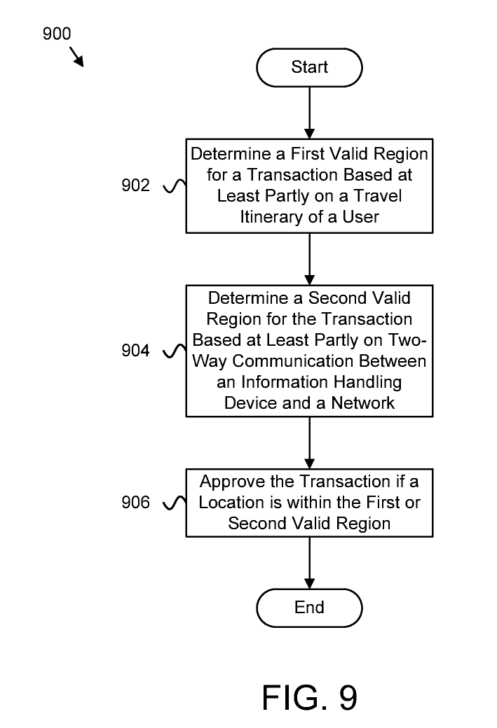

FIG. 9 is a schematic flow chart diagram illustrating one embodiment of a further method 900 for transaction fraud detection. The method 900 begins and the fraud detection module 104 determines 902 a first valid region for a transaction based at least partly on a travel itinerary of a user. In some embodiments, the itinerary module 206 determines 902 the first valid region for the transaction based at least partly on the travel itinerary of the user. In certain embodiments, the travel itinerary is obtained dynamically by accessing a third-party account of the user. The fraud detection module 104 determines 904 a second valid region for the transaction based at least partly on two-way communication between the information handling device 102 and the network 612. In some embodiments, the network module 208 determines 904 the second valid region for the transaction based at least partly on the two-way communication between the information handling device 102 and the network 612. In certain embodiments, the information handling device 102 is not used to initiate the transactions. In some embodiments, the fraud detection module 104 approves 906 the transaction if a location of the transaction is within the first valid region and/or the second valid region, and the method 900 ends. In certain embodiments, the approval module 204 approves 906 the transaction if the location of the transaction is within the first valid region and/or the second valid region.

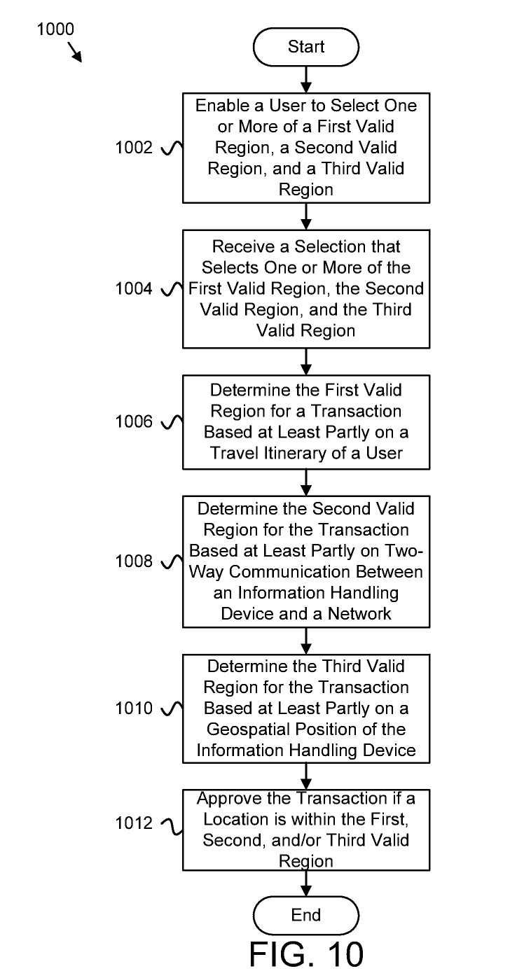

FIG. 10 is a schematic flow chart diagram illustrating one embodiment of an additional method 1000 for transaction fraud detection. The method 1000 begins and the fraud detection module 104 enables 1002 a user to select one or more of a first valid region, a second valid region, and a third valid region for approving a transaction. In some embodiments, the preferences module 306 enables 1002 the user to select one or more of the first valid region, the second valid region, and the third valid region for approving the transaction. Moreover, the fraud detection module 104 receives 1004 a selection of one or more of the first valid region, the second valid region, and the third valid region for approving the transaction. In some embodiments, the preferences module 306 receives 1004 the selection of one or more of the first valid region, the second valid region, and the third valid region for approving the transaction.

The fraud detection module 104 determines 1006 the first valid region for the transaction based at least partly on a travel itinerary of a user. In some embodiments, the itinerary module 206 determines 1006 the first valid region for the transaction based at least partly on the travel itinerary of the user. In certain embodiments, the travel itinerary is obtained dynamically by accessing a third-party account of the user. The fraud detection module 104 determines 1008 the second valid region for the transaction based at least partly on two-way communication between the information handling device 102 and the network 612. In some embodiments, the network module 208 determines 1008 the second valid region for the transaction based at least partly on the two-way communication between the information handling device 102 and the network 612. In certain embodiments, the information handling device 102 is not used to initiate the transactions.

In certain embodiments, the fraud detection module 104 determines 1010 the third valid region for the transaction based at least party on a geospatial position of the information handling device 102. In one embodiment, the positioning module 302 determines 1010 the third valid region for the transaction based at least partly on the geospatial position of the information handling device 102. In some embodiments, the fraud detection module 104 approves 1012 the transaction if a location of the transaction is within the first valid region, the second valid region, and/or the third valid region, and the method 1000 ends. In certain embodiments, the approval module 204 approves 1012 the transaction if the location of the transaction is within the first valid region, the second valid region, and/or the third valid region.

The embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus comprising:
a region determination module that determines a valid region for a transaction, the region determination module comprising at least one of:
an itinerary module that determines the valid region for the transaction based at least partly on a travel itinerary of a user, wherein the travel itinerary is obtained dynamically by accessing a third-party account of the user; and
a network module that determines the valid region for the transaction based at least partly on two-way communication between an information handling device and a network, wherein the information handling device is not used to initiate the transaction; and
an approval module that approves the transaction if a location of the transaction is within the valid region,
wherein at least a portion of the region determination module and the approval module comprise one or more of hardware and executable code, the executable code stored on one or more computer readable storage media.

2. The apparatus of claim 1, wherein the third party account of the user is a travel account.

3. The apparatus of claim 1, wherein the information handling device is associated with the user.

4. The apparatus of claim 1, wherein the information handling device is one of a mobile phone, a watch, a tablet computer, a laptop computer, and a desktop computer.

5. The apparatus of claim 1, wherein the network comprises a cellular network.

6. The apparatus of claim 1, wherein the network comprises a wide area network (“WAN”).

7. The apparatus of claim 1, wherein the third-party account is associated with the user.

8. The apparatus of claim 1, further comprising a linking module that links the third-party account to a user account of the user.

9. The apparatus of claim 1, wherein the region determination module comprises a positioning module that determines the valid region for the transaction based at least partly on a geospatial position of the information handling device.

10. The apparatus of claim 1, further comprising a preferences module that enables the user to select one or both of the itinerary module and the network module for determining the valid region for the transaction.

11. A method comprising:
determining a valid region for a transaction based on at least one of:
a travel itinerary of a user, wherein the travel itinerary is obtained dynamically by accessing a third-party account of the user; and
two-way communication between an information handling device and a network, wherein the information handling device is not used to initiate the transaction; and
approving the transaction if a location of the transaction is within the valid region.

12. The method of claim 11, further comprising linking the third-party account to a user account of the user.

13. The method of claim 11, further comprising determining the valid region for the transaction based at least partly on a geospatial position of the information handling device.

14. The method of claim 11, further comprising enabling the user to select one or both of the travel itinerary of the user and the two-way communication between the information handling device and the network for determining the valid region for the transaction.

15. The method of claim 11, further comprising receiving a selection that selects one or both of the travel itinerary of the user and the two-way communication between the information handling device and the network for determining the valid region for the transaction.

16. A method comprising:
determining a first valid region for a transaction based at least partly on a travel itinerary of a user, wherein the travel itinerary is obtained dynamically by accessing a third-party account of the user;
determining a second valid region for the transaction based at least partly on two-way communication between an information handling device and a network, wherein the information handling device is not used to initiate the transaction; and
approving the transaction if a location of the transaction is within the first valid region, the second valid region, or some combination thereof.

17. The method of claim 16, further comprising determining a third valid region for the transaction based at least partly on a geospatial position of the information handling device.

18. The method of claim 17, further comprising enabling the user to select one or more of the first valid region, the second valid region, and the third valid region for approving the transaction.

19. The method of claim 17, further comprising receiving a selection that selects one or more of the first valid region, the second valid region, and the third valid region for approving the transaction.

20. A computer program product for transaction fraud detection, the computer program product comprising a computer readable storage medium having program instructions embodied therewith, the program instructions executable by a processor to cause the processor to:
determine a valid region for a transaction based on at least one of:
a travel itinerary of a user, wherein the travel itinerary is obtained dynamically by accessing a third-party account of the user; and
two-way communication between an information handling device and a network, wherein the information handling device is not used to initiate the transaction; and
approve the transaction if a location of the transaction is within the valid region.

21. The computer program product of claim 20, wherein the program instructions executable by the processor further cause the processor to link the third-party account to a user account of the user.

22. The computer program product of claim 20, wherein the program instructions executable by the processor further cause the processor to determine the valid region for the transaction based at least partly on a geospatial position of the information handling device.

23. The computer program product of claim 20, wherein the program instructions executable by the processor further cause the processor to enable the user to select one or both of the travel itinerary of the user and the two-way communication between the information handling device and the network for determining the valid region for the transaction.

24. A system comprising:
a processor;
a region determination module that determines, by use of the processor, a valid region for a transaction, the region determination module comprising at least one of:
an itinerary module that determines the valid region for the transaction based at least partly on a travel itinerary of a user, wherein the travel itinerary is obtained dynamically by accessing a third-party account of the user;
a network module that determines the valid region for the transaction based at least partly on two-way communication between an information handling device and a network, wherein the information handling device is not used to initiate the transaction; and
a positioning module that determines the valid region for the transaction based at least partly on a geospatial position of the information handling device; and
an approval module that approves the transaction if a location of the transaction is within the valid region.

25. The system of claim 24, further comprising a preferences module that enables the user to select one or both of the itinerary module and the network module for determining the valid region for the transaction.
